(19) United States
(12) Patent Application Publication
(10) Pub. No.: US 2008/0282987 A1
(43) Pub. Date: Nov. 20, 2008

(54) Cat tower with separable transportable bed, inset corrugated scratch pad/fabric base, and washable woven fabric covers

(76) Inventor: Sharon A. Ritchey, Cave Creek, AZ (US)

Correspondence Address: TOD R. NISSLE, P.C., P.O. Box 55630, Phoenix, AZ, 85078, US

(21) Appl. No.: 11/804,396

(22) Filed: May 17, 2007

(51) Int. Cl. A01K 15/02; A01K 29/00

(52) U.S. Cl. 119/28.5; 119/706

(57) ABSTRACT

A cat tower assembly includes a base and a platform supported above the base. A cat bed is mounted on the platform. The bed includes a peripheral wall held in place by a removable washable woven fabric cover. The bed can be removed from the platform and utilized at a location remote from the cat tower. A removable washable woven fabric cover extends over the base. A corrugated cardboard scratching pad is inset on the base to prevent lateral movement of the pad.

The present invention relates to sleeping and scratching structures used by a cat.

More particularly, the invention pertains to a method and apparatus that facilitates the safe utilization by a cat of a bed and of a scratching pad and that facilitates maintenance of such an apparatus.

So-called “scratching posts” have long been provided for cats and typically comprise carpet stapled to one or more vertically oriented wood posts or to one or more horizontally oriented wood base structures connected to the posts. Literally hundreds of thousands, if not millions, of such units have been sold over the decades, even though the such units suffer from several disadvantages.

One disadvantage is that the staples utilized to secure the carpet to wood in the posts or base can come loose and cut or otherwise create a safety hazard for a cat utilizing the scratching post.

Another disadvantage of such conventional scratching posts is that they are difficult to clean, and as a result, often are not cleaned and become a collection point for dirt, dander, fur, mites, and other like items.

A further disadvantage of such conventional scratching posts is that they are not particularly pleasing aesthetically, which adversely affects sale of such units.

It would be highly desirable to provide an improved cat scratching post that would facilitate maintenance of the scratching post, would improve the safety of the scratching post, and would improve the sale of such posts by making them more aesthetically pleasing.

Therefore, it is an object of the instant invention to provide an improved structure for use by cats.

Another object of the invention is to provide an improved structure of the type described which would eliminate the use of staples, would facilitate cleaning the structure, and would encourage sales of the structure by improving the appearance of the structure.

These and other, further and more specific objects and advantages of the invention will be apparent to those skilled in the art from the following detailed description thereof, taken in conjunction with the drawings, in which:

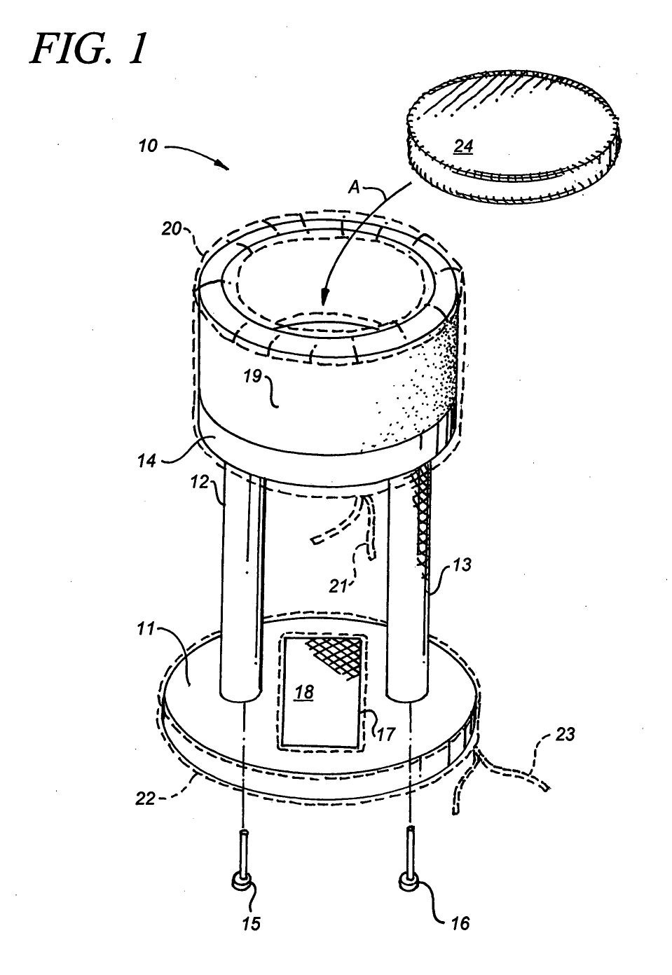

FIG. 1 is a perspective view illustrating a cat structure constructed in accordance with the principles of the invention;

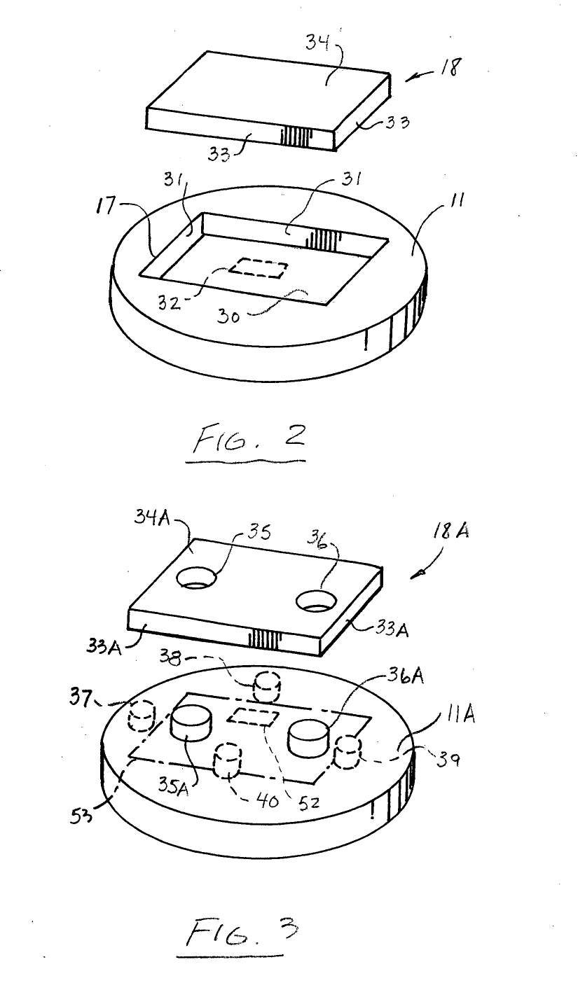

FIG. 2 is a perspective view illustrating a corrugated cardboard scratching pad inset in the base of the structure of FIG. 1;

FIG. 3 is a perspective view illustrating another construction for insetting a corrugated cardboard scratching pad in the base of the structure of FIG. 1;

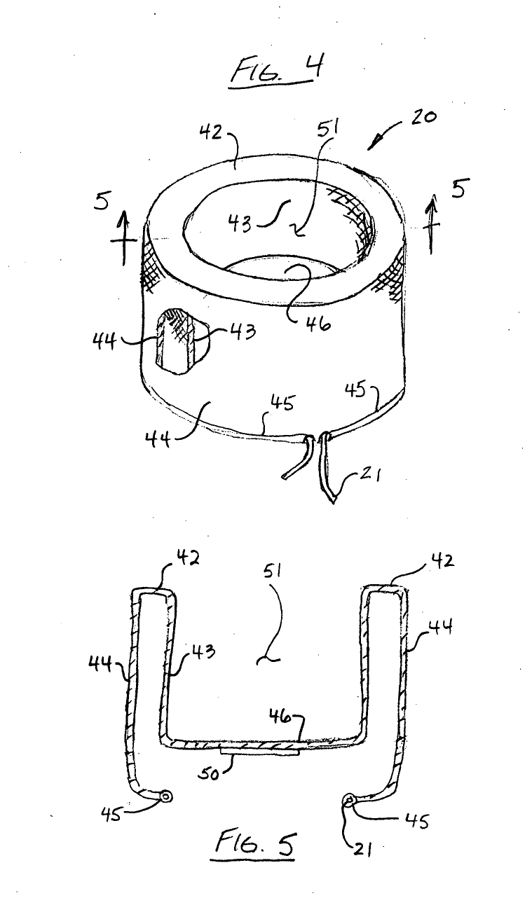

FIG. 4 is a perspective view further illustrating a removable washable woven fabric cover comprising a component of a cat bed utilized on the structure of FIG. 1; and,

FIG. 5 is a section view of the fabric cover of FIG. 4 further illustrating construction details thereof.

Briefly, in accordance with the invention, I provide an improved cat tower. The tower comprises a horizontally oriented base; a horizontally oriented elevated platform spaced above the base; at least one vertically oriented leg supporting the platform and extending between the base and the platform; a cat bed removably mounted on the platform and comprising a peripheral wall extending around an interior area sized to be occupied by a cat and removably mounted on the platform, and a woven fabric, washable cover extending over the peripheral wall and securing the peripheral wall to the platform. The washable cover is removable from the wall and the platform for washing.

In another embodiment of the invention, I provide a cat tower. The tower comprises a horizontally oriented base; a horizontally oriented elevated platform spaced above the base; at least one vertically oriented leg supporting the platform and extending between the base and the platform; and a scratch/covering assembly mounted on one of a pair consisting of the base and the platform. The scratch/covering assembly includes a removable washable woven fabric cover removably mounted on said one of the pair, and, a corrugated cardboard scratch pad inset on said one of the pair to prevent lateral movement of the scratch pad. The scratch pad is adjacent the removable washable fabric cover. The fabric cover has a thickness of less than one and two-tenths millimeters.

In a further embodiment of the invention, I provide an improved method to construct and maintain an apparatus for a cat to scratch and sleep on. The method comprises the step of providing a cat tower including a horizontally oriented base, a horizontally oriented elevated platform spaced above the base, and at least one vertically oriented leg supporting the platform and extending between the base and the platform. The method also includes the steps of mounting a first removable washable woven fabric cover on the base; removably insetting a corrugated cardboard scratch pad on the base adjacent the fabric cover; and, removably mounting a cat bed on the platform. The cat bed comprises a peripheral wall extending around an interior area sized to be occupied by a cat and removably mounted on the platform, and a second woven fabric, washable cover extending over the peripheral wall and securing the peripheral wall to the platform. The second washable cover is removable from the wall and the platform for washing. The method also includes the steps of removing the first removable woven fabric cover from the base; washing the first woven fabric cover; remounting the first woven fabric cover on the base; removing the second woven fabric cover from the platform; removing the peripheral wall from the platform to a location remote from the platform; washing the second woven fabric cover; and, mounting the second woven fabric cover on the peripheral wall at the remote location.

Turning now to the drawings, in which the presently preferred embodiments of the invention are set forth for purposes of illustration, and not limitation, of the invention, and in which like characters refer to corresponding elements throughout the several views, FIG. 1 illustrates a cat tower constructed in accordance with the invention and generally indicated by reference character 10. Tower 10 includes horizontally oriented cylindrical base 11, horizontally oriented cylindrical platform 14 spaced apart from base 11, cylindrical legs 12 and 13 supporting platform 14 and extending between platform 14 and base 11. The shape and dimension of base 11, platform 14 and legs 12 and 13 can vary as desired. Legs 12 and 13 preferably are covered with carpet, sisal material, or other material the cats can use to scratch. The material that covers cylindrical legs 12 and 13 preferably has a hollow tubular shape and can be slid downwardly over and cover a leg 12 and 13 when platform 14 is removed. In this respect, bolts 15 and 16 extend upwardly through apertures (not visible) formed in base 11 and thread into the bottom of legs 12 and 13, respectively, to secure removably legs 12 and 13 to base 11. Similar bolts (not visible) extend downwardly through apertures (not visible) in platform 14 and thread into the top of legs 12 and 13 to secure removably platform 14 to legs 12 and 13. Any desired fasteners or other means can be utilized to secure legs 12 and 13 to base 11 and platform 14.

Before bolts 15 and 16 are utilized to secure legs 12 and 13 to base 11, a woven washable cloth cover 22 or other cover is mounted on and extends over the circular top surface of base 11. The cover 22 also preferably, but not necessarily, extends over the peripheral outer cylindrical edge of base 11 and, to a desired extent, underneath base 11. The cover 22 includes a drawstring 23 that is pulled to tighten cover 22 in position over base 11. Cover 22 need not be provided with a drawstring, and VELCRO fastener material or other fastening systems can be utilized to secure cover 22 on base 11. Importantly, in the practice of the invention, staples, nails, etc. are not utilized and cover 22 can be readily removed from base 11 to be washed and then remounted on base 11.

Although cover 22 could be made in multiple pieces or in other configurations to mount on base 11 after legs 12 and 13 are secured to base 11, it is presently preferred that bolts 15 and 16 are utilized to secure legs 12, 13 to base 11 after cover 22 is wrapped around or otherwise mounted on base 11 and drawstring 23 is tightened and tied in place.

As is illustrated in FIGS. 1 and 2, a corrugated cardboard scratch pad 18 is mounted on base 11. Scratch pad 18 preferably is inset on base 11. One method of insetting a pad 18 is by seating pad 18 in a countersunk opening 17 that is formed in and extends into base 11 and sized to receive pad 18, preferably so the top of pad 18 is flush with the top surface of base 18 in the manner illustrated in FIG. 1. Another method of insetting a corrugated cardboard or other kind of scratch pad 18A is by seating pad 18A over pegs or members 35A, 36A that are connected to base 11 and slidably extend through openings 35, 36 formed in pad 18A (FIG. 3). A further method of insetting a scratch pad 18A is by seating pad 18 intermediate pegs or members 37, 38, 39, 40 that are connected to base 11 and bound the peripheral edge 33A of pad 18A (FIG. 3). In FIG. 3, dashed line 53 indicates the position occupied by pad 18A when it is seated on base 11.

In FIG. 2, when pad 18 is seated in rectangular opening 17, rectangular peripheral edge 33 of pad 18 is adjacent the rectangular peripheral edge of opening 17. If desired, one or more VELCRO (TM) fasteners 32 can be secured to the bottom 30 of opening 17 to contact and engage opposing VELCRO (TM) fasteners (not visible) mounted on the bottom of pad 18 to help secure pad 18 in opening 17. Or, in the event cover 22 is shaped to cover and extend into opening 17, one or more VELCRO (TM) fasteners can be attached to the top of cover 22 to contact and engage opposing VELCRO (TM) fasteners secured to the bottom of pad 18.

In FIG. 3, when pad 18A is seated on pegs 35A, 36A, the outer cylindrical peripheral edges of pegs 35A, 36A are adjacent the inner cylindrical peripheral edges of openings 35, 36.

In FIG. 3, when pad 18A is seated intermediate pegs 37 to 40, pegs 37 to 40 are each adjacent the outer peripheral edge 33A of corrugated cardboard pad 18A.

When a pad 18, 18A is inset in opening 17, inset on pegs 35A, 36A, or inset intermediate pegs 37 to 40, then the opening 17 and pegs 35A, 36A, 37 to 40 perform the important function of capturing pad 18, 18A and preventing the lateral movement of pad 18, 18A.

Base 11, platform 14, and legs 12 and 13 are each preferably, but not necessarily, made from a laminate including corrugated cardboard and/or “board” made by compressing recycled cardboard or other paper products.

The cat bed on platform 14 includes a cylindrical peripheral wall 19 extending around an interior area 51 (FIGS. 4 and 5) sized to be occupied by a cat. Wall 19 is preferably fabricated from a substantially rigid, but soft, foam, or, comprises a hollow cylindrical sleeve filled with polyester fiber or another soft filling. Wall 19 can also be constructed of corrugated cardboard or other more rigid materials. However, either a soft foam or a sleeve with soft polyester fiber is presently preferred. One or more openings can be formed in wall 19 to facilitate a cat's jumping into interior area 51.

A washable woven fabric cover 20 is sized to extend over peripheral wall 19, and, if desired, to extend down around the peripheral cylindrical edge of platform 14 and, to a desired extent, beneath platform 14. Cover 20 functions to generate forces that pull wall 19 downward against platform 14 and that press inwardly against wall 19 to hold wall 19 in registration with platform 14. The cover 20 includes a drawstring 21 that extends through a sleeve or channel 45 on cover 20 and that is pulled to tighten cover 20 in position over wall 19 and, if desired, over the edge and bottom of platform 14. Instead of extending over the edge of platform 14, cover 20 can extend beneath wall 19 and, consequently, intermediate the bottom of wall 14 and platform 14. Cover 20 need not be provided with a drawstring, and VELCRO (TM) fastener material or other fastening systems can be utilized to secure cover 20 on platform 14. Importantly, in the practice of the invention, staples, nails, etc. are not utilized to secure cover 20 on the cat tower, and cover 20 can be readily removed from platform 14 and/or from wall 19 to be washed and then remounted on base 14. Further, peripheral wall 19 can be removed from platform 14 and, along with cover 20 extending over wall 19, placed at a desired location remote from the cat tower 10 to function as a cat bed.

Washable woven fabric covers 20 and 22 are not intended to be utilized as scratch pads. The fabric utilized in covers 20 and 22 has a thickness of 1.2 millimeters or less. Cats scratching such fabric can quickly destroy the fabric. In contrast, the corrugated cardboard pads 18, 18A have an initial thickness of at least one-half inch, preferably at least one inch, and most preferably at least two inches. Consequently, corrugated cardboard pad 18 and, possibly, carpet, sisal, or other material on legs 12 and 13, are provided as a scratch pad.

In one embodiment of the invention, the woven fabric utilized to make covers 20 and 22 is, although pliable and supple, puncture resistant. One example of woven material which can be utilized to fabricate covers 20 and 22 is obtainable from Burlington Industries, 1345A Avenue of the Americas, N.Y., N.Y. 10019, and has the specifications listed below:
Material: High-density interwoven nylon yarn
Style No.: 55116
Weight: 1.5 ounces per square yard
Thickness: Approximately three-thousands ( 3/1000) of an inch
Type of Weave: Plain
Warp: 30 denier nylon yarn, DuPont type 285, zero twist. 240 yarns per inch, 26 filaments per yarn.
Fill: 20 denier nylon yarn. DuPont type 285, zero twist. 200 yarns per inch, 7 filaments per yarn.
Color: White
Coating: None
   The Burlington Industries material described above has a resistance to penetration by a needle which is three to five time greater than the resistance of latex rubber of the same thickness. The material can be utilized in two or more layers to increase puncture resistance. The layers are preferably fastened together so that there is “play” in each layer such that each layer can move or slide laterally at least a short distance with respect to adjacent layers. Such loose layering facilitates threads in the material squeezing a needle, or cat claw, and increases the frictional contact between the threads and a needle, or cat claw. When covers 20 and 22 are fabricated from puncture resistant woven fabric, this tends to encourage a cat to utilize pad 18, and not covers 20 and 22, to scratch.

The combination on base 11 (or if desired on platform 14) of a scratch pad 18 and washable fabric cover 22 is an important feature of the invention. When a cat scratches a pad 13 or other scratching material, pieces of cardboard or other material or residue are loosed by the cat's claws and can be broadcast over a floor. A fabric cover 22 can function to capture at least some of such scratching residue and can be washed to clean residue from cover 22.

As used herein, scratching when used with reference to cats does not include kneading. Kneading occurs when a cat extends and retracts its claws generally without pulling his claws or paws in a lateral to a surface. During kneading, the cat's paws stay substantially in one place and the cat is not pulling its paws toward its body On the other hand, when a cat is scratching, it extends its claws and pulls its paws toward its body.

Covers 20 and 22 can be sold in packages containing multiple covers 20 and/or 22 and can be made from a wide variety of fabric designs, giving a cat owner the ability to change covers 20 and 22 to match seasons of the year, to match fabric design and color on furniture, to match the color of paint on the walls of a residence, etc. Interchanging covers 20 and 22 having different fabric designs and colors is a straightforward matter in the practice of the invention, but is, practically speaking, not possible with the old carpet-staple cat scratching posts.

A pillow or pad 24 (FIG. 1) can be utilized inside wall 19 to provide a soft sleeping area for a cat. A scratch pad 18 can also, if desired, be placed inside wall 19 and on top of platform 14 (or on top of the portion of cover 20 that is resting on the top of platform 14), either alone or in combination with a pillow shaped to extend over platform 14 to at least one side of the scratch pad 18.

Having set forth the presently preferred embodiments of our invention in such terms as to enable those skilled in the art to make and use the invention, I Claim:

1. A cat tower comprising
(a) a horizontally oriented base;
(b) a horizontally oriented elevated platform spaced above said base;
(c) at least one vertically oriented leg supporting said platform and extending between said base and said platform;
(d) a cat bed removably mounted on said platform and comprising
(i) a peripheral wall extending around an interior area sized to be occupied by a cat and removably mounted on said platform, and
(ii) a woven fabric, washable cover extending over said peripheral wall and securing said peripheral wall to said platform, said washable cover removable from said wall and said platform for washing.

2. A cat tower comprising
(a) a horizontally oriented base;
(b) a horizontally oriented elevated platform spaced above said base;
(c) at least one vertically oriented leg supporting said platform and extending between said base and said platform;
(d) a scratch/covering assembly mounted on one of a pair consisting of said base and said platform, said assembly including
(i) a removable washable woven fabric cover removably mounted on said one of said pair, and
(ii) a corrugated cardboard scratch pad inset on said one of said pair to prevent lateral movement of said scratch pad, said pad adjacent said removable washable fabric cover, said fabric cover having a thickness of less than one and two-tenths millimeters.

3. A method to construct and maintain an apparatus for a cat to scratch and sleep on, comprising the steps of
(a) providing a cat tower including
(i) a horizontally oriented base;
(ii) a horizontally oriented elevated platform spaced above said base;
(iii) at least one vertically oriented leg supporting said platform and extending between said base and said platform;
(b) removably mounting a first removable woven fabric cover on said base;
(c) removably insetting a corrugated cardboard scratch pad on said base adjacent said fabric cover;
(d) removably mounting a cat bed on said platform, said bed comprising
(i) a peripheral wall extending around an interior area sized to be occupied by a cat and removably mounted on said platform, and
(ii) a second woven fabric, washable cover extending over said peripheral wall and securing said peripheral wall to said platform, said washable cover removable from said wall and said platform for washing;
(e) removing said first removable woven fabric cover from said base;
(f) washing said first woven fabric cover;
(g) remounting said first woven fabric cover on said base;
(h) removing said second woven fabric cover from said platform;
(i) removing said peripheral wall from said platform to a location remote from said platform;
(j) washing said second woven fabric cover; and,
(k) mounting said second woven fabric cover on said peripheral wall at said remote location.

4. A method to construct and maintain an apparatus for a cat to scratch and sleep on, comprising the steps of
(a) providing a cat tower including
(i) a horizontally oriented base;
(ii) a horizontally oriented elevated platform spaced above said base;
(iii) at least one vertically oriented leg supporting said platform and extending between said base and said platform;
(b) removably mounting a first removable washable woven fabric cover on said base;
(c) removably mounting on said platform a second washable woven fabric cover;
(d) removing said first removable woven fabric cover from said base;
(e) washing said first woven fabric cover;
(f) remounting said first woven fabric cover on said base;
(g) removing said second woven fabric cover from said platform;
(h) washing said second woven fabric cover; and,
(i) remounting said second woven fabric cover on said platform.
